(19) United States
(12) Patent Application Publication
(10) Pub. No.: US 2019/0208789 A1
(43) Pub. Date: Jul. 11, 2019

(54) COMPOSITIONS AND METHODS FOR ENHANCING PLANT GROWTH

(71) Applicants: Victor ESSEL, Sioux Falls, SD (US); Joshua LOEBS, Sioux Falls, SD (US); Ross LOEBS, Vermillion, SD (US); Anna K.O. AUGHENBAUGH, Sioux Falls, SD (US); Tony HAGEN, Sioux Falls, SD (US); BCS BIOMASS, LLC, Sioux Falls, SD (US)

(72) Inventors: Tony HAGEN, Sioux Falls, SD (US); Anna K.O. AUGHENBAUGH, Sioux Falls, SD (US); Ross LOEBS, Vermillion, SD (US); Joshua LOEBS, Sioux Falls, SD (US); Victor ESSEL, Sioux Falls, SD (US)

(73) Assignee: BCS BIOMASS, LLC, Sioux Falls, SD (US)

(21) Appl. No.: 16/323,211

(22) PCT Filed: Aug. 4, 2017
(86) PCT No.: PCT/US17/45633

§ 371 Date: Feb. 4, 2019

Related U.S. Application Data
(60) Provisional application No. 62/371,201, filed on Aug. 4, 2016.

(51) Int. Cl. A01N 65/03; A01N 25/12; C05G 3/04; C05F 11/04; C05F 17/00; C05F 17/02; C05F 7/00

(52) U.S. Cl. CPC A01N 65/03; A01N 25/12; C05G 3/04; C05F 7/00; C05F 17/0018; C05F 17/0027; C05F 17/0276; C05F 11/04

(57) ABSTRACT

Embodiments of the present disclosure generally relate to compositions and methods for enhancing or accelerating plant growth and/or plant productivity. In certain embodiments, compositions and methods disclosed herein concern enhancing growth of terrestrial crops using compositions containing liquid media or growth substrate conditioned by a submersible plant. Other embodiments relate to formulations combining PGPB and various agents that activate and/or promote adhesion of the PGPB to subject plants to improve growth. Still other embodiments relate to improved methods for applying the compositions and formulations disclosed herein to various terrestrial plants.

### CROSS-REFERENCE TO RELATED APPLICATIONS

This application claims priority to U.S. Provisional Patent Application No. 62/371,201, filed on Aug. 4, 2016. This application is incorporated herein by reference in its entirety for all purposes.

### FIELD

Embodiments herein relate to compositions and methods for enhancing plant growth and crop productivity. In certain embodiments, compositions and methods disclosed herein concern enhancing growth of terrestrial crops using compositions containing plant growth promoting bacteria (PGPB) and/or processed submersible plant-conditioned compositions. Other embodiments relate to formulations containing PGPB and various agents that activate and/or promote adhesion of the PGPB to subject plants to improve growth and/or crop productivity. Still other embodiments relate to methods and systems for applying compositions and formulations disclosed herein to various terrestrial plants in order to reduce time to cultivation and harvesting with comparable yield to a crop not receiving such a composition.

### BACKGROUND

The 2007 U.S. census of agriculture illustrated that there were 2.2 million farms that cover an area of 922 million acres (3,730,000 km²), an average of 418 acres (1.69 km²) per farm. Successful farming of this land depends upon many factors. Some of these factors, such as experience, reliable equipment, and appropriate fertilization application are controllable. Uncontrollable factors that can stress the plants include pests and other microbes, prolonged drought, and weather events such as freeze, wind and hail.

Interactions between plants and microbes in the rhizosphere have been demonstrated to improve soil quality, plant growth, and the general health of the plant. Plant growth promoting bacteria (PGPB) are frequently found in many soils, although colonization of plants with PGPB growing in PGPB-infested soil is unpredictable.

### SUMMARY

Embodiments herein relate to compositions and methods for enhancing or accelerating plant growth and/or plant productivity. In accordance with these embodiments, compositions disclosed herein can include one or more strains of plant growth promoting bacteria (PGPB). In accordance with these embodiments, the PGPBs can further be combined with a peat-based mixture; at least one activating agent; and/or at least one adhesive agent.

A method for making a terrestrial plant growth enhancer according to one embodiment of the present disclosure includes growing one or more submersible aquatic plants in a growth substrate submersed in a liquid media, to produce a conditioned growth substrate and a conditioned liquid media. In some embodiments, the method further includes collecting the conditioned growth substrate and/or the conditioned liquid media, and drying the conditioned growth substrate. In some embodiments, the method further includes particulating the dried, conditioned growth substrate to produce a terrestrial plant growth enhancer from the dried conditioned growth substrate and/or the conditioned liquid media.

In some embodiments, the method further includes mixing the terrestrial plant growth enhancer with at least one coating assist or at least one adhering agent. In some embodiments, the at least one coating assist comprises talc, graphite, or a combination thereof. In some embodiments, the adhering agent includes a sugar water mixture, a gum arabic, or a combination thereof.

In some embodiments, particulating the dried, conditioned growth substrate includes grinding, crushing, milling, or pulverizing the dried, conditioned growth substrate.

In some embodiments, the particulated dried, conditioned growth substrate is formulated into a pellet.

In some embodiments, the method further includes at least partially rehydrating the particulated dried, conditioned growth substrate. In some embodiments, the particulated dried, conditioned growth substrate is at least partially rehydrated with water. In some embodiments, a bacterial germination stimulant, a carbon source, a polymer, an adhering agent, and/or a fertilizing agent is added to the at least partially rehydrated particulated dried, conditioned growth substrate.

In some embodiments, the method further includes adding to the collected, conditioned liquid media at a bacterial germination stimulant, a carbon source, a polymer, and/or a fertilizing agent.

In some embodiments, the bacterial germination stimulant includes at least one of gamma-aminobutyric acid (GABA) and/or monosodium glutamate (MSG). In some embodiments, the carbon source comprises glycerol. In some embodiments, the adhering agent includes a sugar.

A method for treating a terrestrial plant according to another embodiment of the present disclosure includes growing one or more submersible aquatic plants in a growth substrate submersed in a liquid a media to produce a conditioned growth substrate and a conditioned liquid media. In some embodiments, the method further comprises collecting at least one of the conditioned growth substrate and the conditioned liquid media, and drying the conditioned growth substrate. In some embodiments, the method further includes particulating the dried, conditioned growth substrate to produce a terrestrial plant growth enhancer from the dried conditioned growth substrate and/or the conditioned liquid media, and applying the conditioned liquid media to foliage of the terrestrial plant.

A method for treating a terrestrial plant according to another embodiment of the present disclosure includes growing one or more submersible aquatic plants in a growth substrate submersed in a liquid a media to produce a conditioned growth substrate and a conditioned liquid media, collecting at least one of the conditioned growth substrate and the conditioned liquid media, and drying the conditioned growth substrate and particulating the dried, conditioned growth substrate to produce a terrestrial plant growth enhancer from at least one of the dried conditioned growth substrate and the conditioned liquid media, and providing the conditioned liquid media to a field of terrestrial plants or a crop.

A method for making a terrestrial plant growth enhancer according to one embodiment of the present disclosure includes growing one or more submersible aquatic plants in a growth substrate to produce a conditioned growth substrate, collecting the conditioned growth substrate, fermenting the collected conditioned growth substrate, and collecting a fermentation liquid, wherein the fermentation liquid is the terrestrial plant growth enhancer. In some embodiments, the conditioned growth substrate is dried and particulated prior to the fermentation step.

In some embodiments, the fermenting step includes combining the conditioned growth substrate with water and at least one microbial nutrient source. In some embodiments, the at least one microbial nutrient source comprises sugar. In some embodiments, the sugar is cane sugar.

In some embodiments, the method further includes adding acetic acid during the fermenting step. In some embodiments, the acetic acid is added as a solution from 2% to 10% acetic acid.

In some embodiments, fermenting the conditioned growth substrate occurs in the presence of unchlorinated water.

In some embodiments, fermenting includes fermenting for at least 12 hours, at least 24 hours, at least 48 hours, or at least 96 hours.

In some embodiments, the method further includes concentrating the fermentation liquid. The fermentation liquid can be concentrated by, for example, filtration, centrifugation, dehydration, or a combination thereof.

In some embodiments, the terrestrial plant growth enhancer can be combined with a least one carbon source. In some embodiments, the at least one carbon source includes glycerol. In some embodiments, the terrestrial plant growth enhancer and the carbon source can be combined with at least one carbon source and/or combined with a polymer.

In some embodiments, the fermentation liquid can be applied to a carrier, followed by drying the treated carrier, and particulating the dried, treated carrier to produce a concentrated terrestrial plant growth enhancer.

In some embodiments, the concentrated terrestrial plant growth enhancer can be combined with at least one coating assist. In some embodiments, the at least one coating assist includes talc, graphite, or a combination thereof.

In some embodiments of the methods described herein, the growth substrate includes peat.

In some embodiments of the methods described herein, the submersible aquatic plants are one or more members of the Potamogetonaceae family. In some embodiments, the submersible aquatic plants of the Potamogetonaceae family are Stuckenia pectinata plants (sago pondweed).

A terrestrial plant growth enhancer according to one embodiment of the present disclosure can be produced by any of the methods described herein.

A method for treating a terrestrial plant seed according to one embodiment of the present disclosure includes first applying an adhering agent to the terrestrial plant seed and subsequently applying the terrestrial plant growth enhancer, produced by a method described herein, to the terrestrial plant seed to produce a treated terrestrial plant seed.

A method for treating a terrestrial plant according to another embodiment of the present disclosure includes providing to a terrestrial plant a terrestrial plant growth enhancer produced a method described herein.

A method for enhancing or accelerating growth in a terrestrial plant according to another embodiment of the present disclosure includes growing a plant from a treated terrestrial plant seed.

A method for enhancing growth in a terrestrial plant according to another embodiment of the present disclosure includes providing a terrestrial plant growth enhancer, produced by a method described herein, to a terrestrial plant.

A composition for enhancing or accelerating growth of a terrestrial plant according to an embodiment of the present disclosure includes a conditioned liquid media, wherein the conditioned liquid media was obtained from a submersible plant after a predetermined growth period, and a peat-based mixture.

A composition for enhancing or accelerating growth of a terrestrial plant according to an embodiment of the present disclosure includes conditioned liquid media, wherein the conditioned liquid media was obtained from a submersible plant after a predetermined growth period.

A composition for enhancing or accelerating growth of a terrestrial plant according to another embodiment of the present disclosure includes a conditioned growth substrate, wherein a growth substrate supported growth of one or more submersible plants for a sufficient growth period to produce the conditioned growth substrate. In some embodiments, the composition further includes a peat-based mixture.

In some embodiments, any of the compositions described herein further include at least one bacterial germination stimulant.

In some embodiments, any of the compositions described herein further include at least one adhesive agent.

In some embodiments, a composition described herein includes least one species of plant growth promoting bacteria (PGPB). In some embodiments, the at least one species of PGPB includes Bacillus spp. In some embodiments, the Bacillus spp. includes one or more of Bacillus subtilis, Bacillus licheniformis, Bacillus amyloliquefaciens. Bacillus atrophaeus. Bacillus mojavensis. Bacillus vallismortis, and Bacillus sonorensis.

In some embodiments of a composition described herein, the one or more submersible plants are Stuckenia pectinata plants (sago pondweed). In some embodiments, the at least one species of PGPB are obtained from Stuckenia pectinata plants (sago pondweed).

In some embodiments of a composition described herein, the peat-based mixture includes peat exposed to Stuckenia pectinata plants (sago pondweed).

In some embodiments of a composition described herein, the at least one bacterial germination stimulant includes one or more of a saprophytic organism, gamma-aminobutyric acid and monosodium glutamate.

In some embodiments of a composition described herein, the at least one adhesive agent includes a sugar-based mixture.

In some embodiments, a composition described herein is formulated for application to one or more tissues of a plant.

In some embodiments, a composition described herein is formulated for application to one or more of the roots, seeds, and leaves of a terrestrial plant.

In some embodiments, a composition described herein is formulated to cause endophytic population of one or more tissues of a terrestrial plant with a plant growth promoting bacteria.

In some embodiments of a composition described herein, the composition further includes a fertilizing agent. In some embodiments, the fertilizing agent comprises an inorganic fertilizing agent including one or more of sodium nitrate, ammonium sulfate, and ammonium phosphate. In some embodiments, the fertilizing agent includes an organic fertilizing agent including one or more of manure, compost, and bone meal.

In some embodiments of a composition described herein, the plant includes one or more of wheat, triticale, corn, soybeans, alfalfa, sorghum, sugar beets, barley, oats, sunflowers, potatoes, carrots, triticale, fruit trees, pistachio trees, pecan trees, tomatoes, strawberries, raspberries green pepper, red kidney beans, okra, celery, lettuce, pansies and other horticultural species, nut-producing plants and horticultural trees.

In some embodiments of a composition described herein, the composition promotes the growth of one or more tissues of the plant.

A method for enhancing or accelerating the growth of a plant according to another embodiment of the present disclosure includes providing the plant with a composition described herein. In some embodiments, the method further includes exposing the plant tissue to a peat-based mixture. In some embodiments, the method further includes exposing the plant to at least one bacterial germination stimulant.

In some embodiments, the peat-based mixture includes a peat growth medium conditioned by a sago pondweed.

In some embodiments, the bacterial germination stimulant includes one or more of gamma-aminobutyric acid and monosodium glutamate.

In some embodiments, the composition is applied to one or more of the roots, seeds, and leaves of the subject plant.

In some embodiments, the plant is one or more of wheat, triticale, corn, soybeans, alfalfa, sorghum, sugar beets, barley, oats, sunflowers, potatoes, carrots, triticale, fruit trees, pistachio trees, pecan trees, alfalfa, hay, tomatoes, strawberries, raspberries green pepper, red kidney beans, okra, celery, lettuce, pansies and other horticultural species, nut-producing plants, and horticultural trees.

In some embodiments, the composition promotes the growth of one or more tissues of the plant.

In some embodiments, the composition increases wheat plant head weight by at least about 10% as compared to untreated wheat plants.

In some embodiments, the composition accelerates growth rate of the plant compared to a plant not exposed to the composition.

### BRIEF DESCRIPTION OF THE DRAWINGS

The following drawings form part of the instant specification and are included to further demonstrate certain aspects of particular embodiments described herein. The embodiments may be better understood by reference to one or more of these drawings in combination with the detailed description presented herein.

FIG. 1 represents an exemplary nitrogen fixation determination plate used to characterize PGPB, according to one embodiment of the present disclosure.

FIG. 2 represents exemplary aminocyclopropane-1-carboxylate (ACC) deaminase activity determination plates used to characterize PGPB, according to one embodiment of the present disclosure.

FIG. 3 represents an exemplary phylogenetic tree depicting evolutionary relationships of various endophytic PGPB strains, according to one embodiment of disclosure.

FIG. 4 represents an exemplary phylogenetic tree depicting evolutionary relationships of various Bacillus bacteria, according to one embodiment of the disclosure.

FIG. 5 is an exemplary flow chart representing various processes for generating and applying a plant growth enhancer, according to embodiments of the disclosure.

FIG. 6 is a photograph of exemplary wheat plants treated with a plant growth enhancer of the present disclosure (left) and untreated control plants (right) demonstrating enhanced growth, according to one embodiment of the disclosure.

FIG. 7 is a photograph of exemplary alfalfa plants treated with a plant growth enhancer of the present disclosure (left) and untreated control plants (right) demonstrating enhanced growth, according to one embodiment of the disclosure.

FIG. 8 is a photograph of exemplary potatoes treated with a plant growth enhancer of the present disclosure (left) and untreated control potatoes (right) demonstrating enhanced growth, according to one embodiment of the disclosure.

FIG. 9 is a photograph of exemplary titicale plants treated with a plant growth enhancer of the present disclosure (left) and untreated control plants (right) demonstrating enhanced growth, according to one embodiment of the disclosure.

### DETAILED DESCRIPTION

In the following sections, various exemplary plant growth enhancers and methods for making and using the plant growth enhancers are described in order to detail various embodiments. It is recognized by one skilled in the art that practicing the various embodiments does not require the employment of all or even some of the specific details outlined herein, but rather that concentrations, times and other specific details may be modified through routine experimentation. In some cases, well known methods or components have not been included in the description.

Embodiments herein relate to compositions and methods for enhancing or accelerating plant growth, improving crop productivity or enhancing or accelerating plant growth and improving crop productivity. In certain embodiments, methods disclosed herein concern enhancing growth of terrestrial plants using plant growth enhancers containing plant growth promoting bacteria (PGPB) and conditioned medium. Some embodiments provide methods for making a plant growth enhancer. Other embodiments relate to formulations that combine PGPB with various agents that promote adhesion of the PGPB to subject plants or seeds as applicable and/or activate the PGPB to improve plant growth and/or productivity. Still other embodiments relate to methods for applying the plant growth enhancers and formulations disclosed herein to various terrestrial subject plants.

In certain embodiments, plant growth enhancers can be made by growing submersible aquatic plants, for example, from the Potamogelonaceae family, in a substrate (e.g., a growth substrate) submersed in a liquid media to produce a conditioned growth substrate and a conditioned liquid media. Following a sufficient growth period, the conditioned growth substrate can be collected and dried, and/or the conditioned liquid media can be collected. In accordance with these embodiments, the dried, conditioned growth substrate can then be particulated (e.g., ground, crushed, milled, or pulverized) to produce a particulated plant growth enhancer. In other embodiments, the collected conditioned liquid media can be used directly as a plant growth enhancer on a plant or crop, can be concentrated, can be mixed applied to or mixed with a carrier for example, a peat-based mixture. In accordance with these embodiments, the conditioned liquid media mixture can be used as a plant growth enhancer or accelerant.

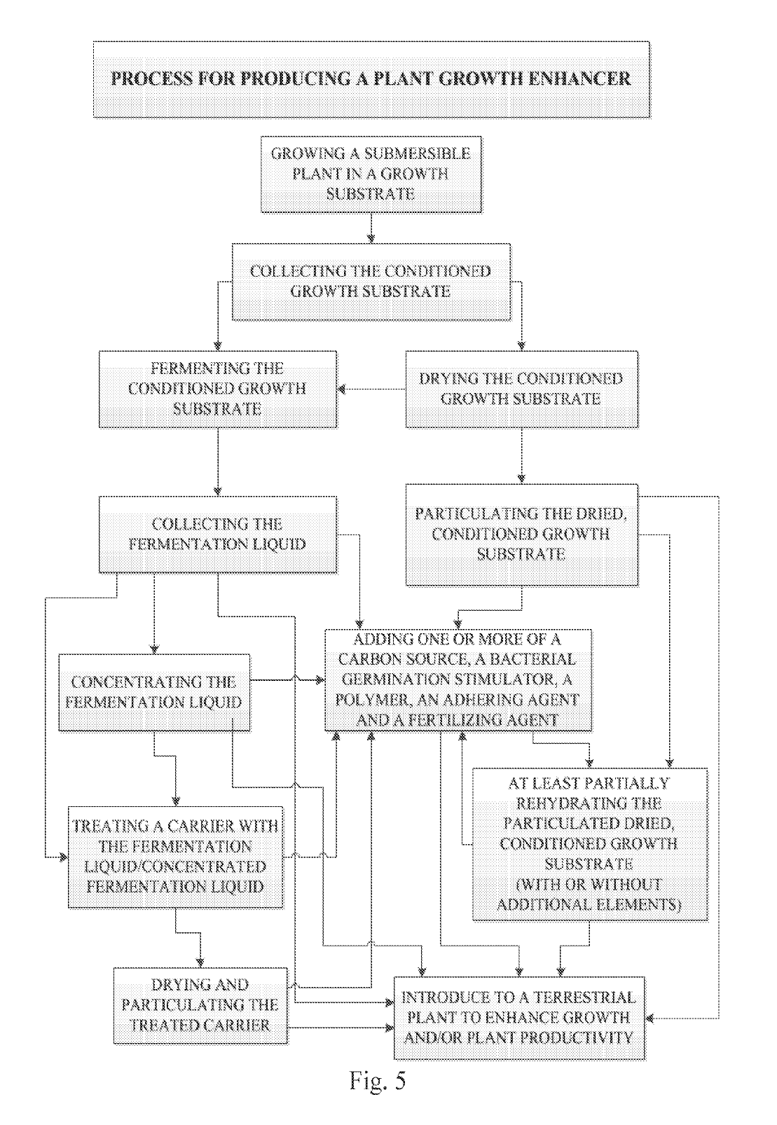

One exemplary flowchart represented in FIG. 5 provides an overview of some methods for making a plant growth enhancer described herein.

In some embodiments, a sufficient growth period for growing the submersible plants can be the period of time required for the submersible aquatic plants to release an effective amount of plant growth promoting bacteria or other plant growth promoting elements into the growth substrate and/or liquid growth media. In some embodiments, the sufficient growth period can be from about 1 month to about 1 year or about 1 month to about 6 months or about 3 month to about 6 months. In certain embodiments, the sufficient growth period can be about 6 months.

In certain embodiments, the submersible aquatic plants from the Potamogetonaceae family can be, for example, sago pondweed plants (Stuckenia pectinata). In accordance with these embodiments, sago pondweed tubers can be planted in a growth substrate, covered with a liquid media, and allowed to develop. In certain embodiments, the submersible plants can be grown in a closed system having access to conditioned liquid media. In other embodiments, the submersible plants can be grown in a growth substrate of for example, an organic peat sediment matrix including at least one of living peat and/or dead peat (e.g., sphagnum moss or hypnum peat). Peat can also include humic extract of peat, duckweed or a combination thereof.

In certain embodiments, the liquid media provided to the submersible plants can be water. In some embodiments, the liquid media provided to the submersible plants can be unchlorinated water or other suitable media.

In other embodiments, conditioned growth substrate and/or conditioned liquid media can include terrestrial plant growth enhancers such as antioxidants, antibacterial components introduced to the conditioned growth substrate or the conditioned liquid media, and/or close microbial associates, for example, plant growth promoting bacteria (PGPB). In accordance with these embodiments, conditioned growth substrate and conditioned liquid media can also include auxins (plant growth hormones) for example, auxins released by bacteria and/or fungi in order to further enhance terrestrial plant growth. In some embodiments, the submersible aquatic plants can be removed from the conditioned growth medium (e.g., following a sufficient growth period). In other embodiments, the plants are allowed to die in the conditioned growth medium before being removed. In yet other embodiments, the conditioned growth medium is removed from the growth chamber of the submersible plants and fresh medium is added and this step is repeated. In other embodiments, removal of the conditioned growth medium is a continuous process where part of the conditioned growth medium is removed from the growth chamber while fresh medium is added after a period of growth of the submersible plants.

In some embodiments, following removal of the plants from the conditioned growth medium, the conditioned growth medium can be collected and dried. In accordance with these embodiments, the conditioned growth medium can be air dried. In certain embodiments, the conditioned growth medium can be dried using heated air. In accordance with these embodiments, the dried, conditioned growth substrate can then be particulated to produce a dispersible plant growth enhancer. In certain embodiments, the plant growth enhancer can be a dried peat-based substance having plant growth-enhancing properties. In certain embodiments, the plant growth-enhancing properties are conferred by PGPB obtained from the submersible plant conditioned growth substrate or exogenously added to a conditioned growth substrate.

In some embodiments, the dried, conditioned growth substrate can be particulated by, for example, grinding, crushing, milling, or pulverizing to produce a plant growth enhancer. In accordance with these embodiments, the particulated plant growth enhancer can be applied to a terrestrial plant or mixed with other growth enhancing agents and then applied to a terrestrial plant.

In certain embodiments, the plant growth enhancer (e.g. particulated or not particulated) can include one or more bacterial germination stimulators, including but not limited to, gamma-aminobutyric acid (GABA) and monosodium glutamate (MSG).

In some embodiments, drying of the conditioned growth substrate can cause bacteria or fungi present in the condition growth substrate or PGPB to form spores. In certain embodiments, the dried conditioned growth substrate composition can be rehydrated or at least partially rehydrated. In accordance with these embodiments, the dried conditioned growth substrate composition can be rehydrated with, for example, water or other suitable media.

In certain embodiments, the plant growth enhancer produced by the above methods can be mixed with one or more coating assists. In some embodiments, the coating assist can be a talc or a graphite. In accordance with these embodiments, the coating assist can assist the plant growth enhancer in sticking or adhering to a plant seed by, for example, electrostatic interactions. In addition, coating assists can also act as lubricants, by for example, decreasing wear in mechanical seeding mechanisms. In other embodiments, a coating assist is first applied to a plant seed followed by application of a plant growth enhancer disclosed herein. In accordance with these embodiment, application of these agents can be performed using a mixing device (e.g. a cement mixer or other mixer either hand-operated or automated)

In some embodiments, conditioned liquid growth media can be collected one or more times throughout the growth period. In certain embodiments, conditioned liquid growth media can be collected after the submersible aquatic plants are removed from the conditioned growth medium.

In some embodiments, the conditioned liquid growth media can be concentrated. In accordance with these embodiments, the conditioned liquid growth media can be concentrated by any means, including but not limited, to filtration, centrifugation, and dehydration.

In certain embodiments, the conditioned liquid growth media or the concentrated conditioned liquid growth media can be mixed with a peat-based component or agent. In accordance with these embodiments, the peat-based component can include peat alone, or peat with another substance such as a clay particulate. In some embodiments, the peat-based component can be a peat-based mixture exposed to submersible aquatic plants, such as Stuckinia pectinata plants. In certain embodiments, the peat-based mixture can be collected conditioned growth substrate.

In some embodiments, a plant growth enhancer can be applied directly to plant seeds. In other embodiments, the plant growth enhancer/coating assist mixture can be applied to plant seeds. In certain embodiments, where adhesion of the plant growth enhancer is not an issue, for example, with seed potatoes or where the plant growth enhancer is a conditioned liquid growth media, the plant growth enhancer can be applied directly, without a coating assist. In other embodiments, where the growth enhancer may not readily stick to a plant seed, a coating assist can be used prior to applying the plant growth enhancer. In certain embodiments, plants grown from the seed treated exposed to plant growth enhancers disclosed herein can exhibit enhanced growth characteristics or demonstrate accelerated growth. In certain embodiments, an adhering agent can be used in place of the coating assist. In some embodiments, the adhering agent can be, for example, an aqueous sugar mixture (e.g., sugar water), or gum arabic. Other similar adhering agents may also be used.

In other embodiments, a plant growth enhancer can be made by fermenting the collected conditioned growth substrate produced by the methods described herein and collecting the resulting fermentation liquid. In accordance with these embodiments, the fermentation liquid, which includes plant growth enhancers such as antioxidants, antibacterial components produced by the plants, and or close microbial associates such as plant growth promoting bacteria (PGPB) externally added or derived from conditions growth substrate, can be used as a plant growth enhancer. In certain embodiments, the fermentation process can include mixing a sample of the conditioned growth substrate with water and adding at least one nutrient source that can support and sustain microbial growth. In some embodiments, the water used in the fermentation is unchlorinated water. In certain embodiments, the nutrient source can be sugar, such as pure cane sugar. In some embodiments, acetic acid (about 1.0%-about 10.0% v/iv) can be included in the fermentation mixture. In some embodiments, the fermentation mixture can be allowed to ferment for at least 12 hours. In other embodiments, the fermentation mixture can be allowed to ferment for at least 24 hours. In yet other embodiments, the fermentation mixture can be allowed to ferment for about 24 to about 96 hours. The fermentation time can be adjusted to provide for a desired microbial concentration at the end of fermentation. In certain embodiments, increasing the fermentation time can produce a higher concentration of microorganisms, including for example, PGPB. In some embodiments, concentrations of microorganisms can also be affected by the concentration of, for example, sugar or other nutrient source provided in the fermentation mixture.

In other embodiments, the collected fermentation liquid can be concentrated to provide a concentrated fermentation liquid having a high concentration of microorganisms, including PGPB. In certain embodiments, the fermentation liquid can be concentrated by any methods, including but not limited to filtration, centrifugation, and dehydration.

In some embodiments, the fermentation liquid or concentrated fermentation liquid can be formulated into a seed treatment. In certain embodiments, the seed treatment can include at least one carbon source, such as, for example, glycerol. The seed treatment can also include a polymer, which in certain embodiments, can act as a lubricant. In some embodiments, the seed treatment has a known PGPB colony count. This can help to ensure consistent and effective seed treatment.

In certain embodiments, the seed treatment can include a bacterial germination stimulator, such as gamma-aminobutyric acid (GABA) and/or monosodium glutamate (MSG).

In some embodiments, seed can be treated with a seed treatment described herein. In certain embodiments, plants grown from the seed treated with a seed treatment described herein can exhibit enhanced growth characteristics.

In other embodiments, the concentrated fermentation liquid can be diluted and applied to a subject plant by, for example, spraying. In certain embodiments, the dilution of the concentration fermentation liquid can be evenly applied to subject plants, including entire crops of subject plants. In some embodiments, subject plants treated with the dilution of concentrated fermentation liquid can exhibit enhanced growth characteristics.

In certain embodiments, the dilution of the concentrated fermentation liquid can include one or more bacterial germination stimulators, such as gamma-aminobutyric acid (GABA) and monosodium glutamate (MSG).

In some embodiments, the fermentation liquid or the concentrated fermentation liquid can be applied to a carrier and then dried and particulated. In some embodiments, the carrier can be peat similar to that used in the growth substrate described above. The resulting particulated carrier can be used as a plant growth enhancer. In certain embodiments, a bacterial germination stimulator, such as gamma-aminobutyric acid (GABA) and/or monosodium glutamate (MSG) can also be applied to the carrier. Using this method, a higher number (or concentration) of, for example, PGPB, can be attained per unit mass of carrier compared to the above method, where the growth substrate is directly formed into a growth enhancer. The fermentation step can act as a concentrating or PGPB enhancing step in such embodiments. The resulting dried, particulated plant growth enhancer can be applied to seeds, or mixed with a coating assist and applied to seeds, as described above.

In some embodiments, increased plant growth and/or productivity can occur when plant extract or PGPB isolated from sago pondweed (Stuckenia pectinata) or other members of the Potamogetonaceae family, is applied to a subject plant such that the plant extract or bacterial isolates come into contact with the roots or other tissue of the subject plant. In certain embodiments, the growth enhancement can be associated with antioxidants, antibacterial components produced by the plants, and/or close microbial associates such as plant growth promoting bacteria (PGPB). The increased growth can also be due to the production of auxins (plant growth hormones) released by bacteria and/or fungi, as well as alternate nitrogen fixation pathways.

In some embodiments, conditioned growth enhancing substrate or conditioned growth enhancing media can be formulated into a spray or formulated as a powder or particulate for more uniform distribution on crops, such as row crops or food-producing trees. In certain embodiments, conditioned growth substrate or conditioned growth media can be applied to a plant or tree to increase nitrogen fixation. In yet other embodiments, treated plants or seeds can be stored for later use or growth. In some embodiments growth enhancing substrate or media can be used to increase stem thickness, increase stem production, increase stem height, increase germination, increase node or pod production or tillering and/or increase the length of photosynthesis by a terrestrial plant treated with conditioned growth substrate or conditioned growth media.

Submersible aquatic plants, such as those of the Potamogetonaceae family (e.g., sago pondweed), can be used as the basis for extracting an inoculate that improves the growth of a subject plant when the inoculate is brought into contact with one or more tissues of the subject plant. In some embodiments, the sago pondweed dies and deposits PGPB into the peat matrix, forming a conditioned growth substrate, which can then be applied to a subject plant. In other embodiments, extracts containing PGPB can be obtained directly from living sago pondweed and combined with other agents and be applied to a subject plant.

PGPB are highly diverse in promoting plant growth; however, the relationship between a PGPB and a subject plant depends on the species of the subject plant as well as the strains of the PGPB. It is surprising that a single composition or formulation that includes PGPB can enhance or accelerate the growth of a phylogenetically diverse array of plants. The two major classifications of PGPB are rhizospheric and endophytic. Rhizopheric relationships involve the colonization of plant root surfaces or superficial intercellular spaces. This colonization usually leads to the formation of root nodules. In endophytic relationships, the PGPBs are known to reside and grow within the plant's apoplastic spaces while contributing their effect to the plant.

One beneficial process attributed to rhizobacteria is nitrogen fixation. Plants lack the ability to incorporate nitrogen gas (N₂) directly into their root system due to the high energy required to breakdown the triple bond. Rhizobacteria are able to convert N₂ to ammonia (NH₃), which the subject plant can assimilate as a source of nitrogen. In some embodiments, plant matter and/or PGPB isolated directly from sago pondweed, or present in a plant growth enhancer described herein, can facilitate nitrogen fixation, which, when applied to a subject plant, can enhance orthe growth characteristics of the subject plant as identified in embodiments disclosed herein.

In some embodiments, the plant growth enhancers and formulations of the present disclosure include endophytic bacteria obtained from a submersible aquatic host plant, such as a member of the Potamogetonaceae family. For example, the endophytic bacteria can be PGPB strains of a host plant, having various characteristics that facilitate enhanced plant growth. In some embodiments, endophytic PGPB from a host plant exhibit at least one of siderophore production, nitrogen fixation activity, phosphate solubilization activity, 1-aminocyclopropane-1-carboxylate (ACC) deaminase activity, indole-3-acetic acid (IAA) and/or indole-3-butyric acid (IAB) expression, and gibberellic acid expression. In some embodiments, more than one endophytic PGPB can be isolated, where in combination, the PGPB exhibit all six characteristics. In other embodiments, a single isolated PGPB can exhibit all six characteristics. In some embodiments, one or more strains of endophytic PGPB can be of the Bacillus genus.

In some embodiments. PGPB-containing plant growth enhancers and formulations of the present disclosure can be applied to various subject plants to enhance or accelerate their growth and/or increase their yield of, for example, forage, fruit, or seeds. For example, plant growth enhancers can include one or more strains of PGPB derived from a submersible aquatic plant such as sago pondweed. In some embodiments, formulations disclosed herein can include peat or a similar soil-based material for growing and/or dispersing the PGPB composition to one or more subject plants. In other embodiments, formulations can include an activating agent that stimulates the growth and/or germination of PGPB and or penetration of the PGPB into the subject plant.

In some embodiments, compositions and methods for enhancing plant growth as described herein can be prepared by combining strains of endophytic PGPB of the Bacillus genus with various other agents to enhance or accelerate the growth of a subject plant. For example, strains of endophytic PGPB of the Bacillus genus that can be used include, but are not limited to, one or more of Bacillus subtilis, Bacillus licheniformis. Bacillus amyloliquefaciens. Bacillus atrophaeus. Bacillus mojavensis. Bacillus vallismortis. Bacillus sonorensis, and Bacillus pumilus. In some embodiments, one or more of these strains of Bacillus bacteria can be combined with dry peat sediment that has been used to grow a submersible aquatic plant such as sago pondweed (e.g., “conditioned peat”) and that has been subsequently particulated into a powder. In some embodiments, this composition can be dried, thus causing the strains of the Bacillus bacteria to form spores. In certain embodiments, this composition can then be rehydrated (or applied in a furrow, for example, which will then be watered after planting) and delivered to a subject plant to enhance or accelerate its growth.

In some embodiments, the dry peat sediment can contain an agent that stimulates the germination of the Bacillus spores, thus allowing the Bacillus bacteria to colonize the subject plant. In some embodiments, the agent can be a bacterial germination stimulant, and can include, for example, gamma-aminobutyric acid (GABA) and/or monosodium glutamate (MSG). Application of a composition that includes GABA and MSG can enhance the germination of the Bacillus and/or promote Bacillus bacteria replication.

In some embodiments, plant growth enhancers and formulations thereof can be applied to various subject plants to enhance or accelerate their growth and/or increase their yield of, for example, forage, fruit, or seeds using various methods. For example, plant growth enhancers and formulations thereof can be sprayed onto a subject plant (i.e., foliar application), can be applied to the roots of a subject plant using a root drench application; and/or can be applied to seeds of a subject plant using a seed-coat, a soil application, or a furrow application or as an aqueous solution. Subject plants can include almost any terrestrial plant. Subject plants include, but are not limited to, wheat, triticale, corn, soybeans, alfalfa, sorghum, sugar beets, barley, oats, sunflowers, potatoes, triticale, fruit trees, tomatoes, strawberries, green pepper, red kidney beans, pansies and other horticultural species, and trees such as the cottonwood. In some embodiments, PGPB compositions can be delivered to a wheat plant and can cause a 2 to 5%, or more increase, in the head weight of or production of the wheat plant.

In some embodiments, plant growth enhancers and formulations thereof can be applied to various subject plants such as fruit trees or, for example, strawberries. In certain embodiements, plant growth enhancers can delay flowering and enhance the ability of the fruit trees or other plants to produce green matter. In some embodiments, the plant growth enhancers and formulations thereof inhibit ethylene production in a subject plant. Ethylene can then be applied to the subject plant to overcome this inhibition, promoting an ethylene response in the plant. This can cause flowering, increases in growth, and increases in fruit yield.

In certain embodiments, the method of application of the plant growth enhancer or formulation thereof can affect the type of growth enhancement response in a subject plant. For example, if applied directly to the roots of a strawberry plant, the plant will produce more strawberries than an untreated plant. If applied to the foliage, the plant will produce more green foliage than an untreated plant, but will not produce strawberries.

In some embodiments, plant growth enhancers and formulations thereof of the present disclosure can include other agents that also can enhance or accelerate plant growth. For example, the plant growth enhancers and formulations thereof of the present disclosure can include one or more fertilizing agent, such as an organic or inorganic fertilizing agent. In certain embodiments, inorganic fertilizers include sodium nitrate, ammonium sulfate, ammonium phosphate, and the like. In other embodiments, organic fertilizers include manure, compost, and bone meal. Other fertilizing agents can also be include in the PGPB compositions and formulations of the present disclosure, as would be recognized by one of ordinary skill in the art based on the present disclosure.

### EXAMPLES

The following examples are included to demonstrate certain embodiments presented herein. It is appreciated by those of skill in the art that the techniques disclosed in the Examples which follow represent techniques discovered to function well in the practices disclosed herein, and thus can be considered to constitute possible modes for its practice. However, those of skill in the art should, in light of the present disclosure, appreciate that many changes can be made in the specific embodiments which are disclosed and still obtain a like or similar result without departing from the spirit and scope herein.

### Example 1—Enhanced Growth of Plants Grown in Bioreactor

In one exemplary method, a bioreactor was filled to a level of 24 inches with hypnum peat and mixed at 10% by volume with clay particulate. This bioreactor was then filled with water to a level of 18 inches above the peat and planted with sago pondweed (Stuckenia pectinata) tubers. The bioreactor was supplemented with soil collected from lakes in South Dakota and other areas. After a growing period, the bioreactor tank was drained of water, leaving behind the dormant plant tissue in the growth substrate. The bioreactor tank remained uncovered and exposed to the atmosphere in the greenhouse for the duration of the experiment. Weed seeds were introduced to the growth substrate left behind in the tank by natural means.

The tank was not fertilized or watered intentionally. Water sources were limited to the water that condensed on the roof covers of the greenhouse and dripped off into the tank and the increased humidity in the greenhouse as a result of evaporation from other remaining bioreactors in the greenhouse. Temperatures in the greenhouse ranged from an ambient 55° F. at night to sustained highs in excess of 100° F. during the summer months. The greenhouse was heated to a minimum of 50° F. during the winter months.

Plants showing increased growth not typical of terrestrial plants surrounding the bioreactor were found growing in the bioreactor. These plants included cottonwood tree, black nightshade, velvet leaf, and water hemp.

As illustrated by Table 1 below, these plants exhibited enhanced growth when grown in conditioned growth substrate including the PGPB from sago pondweed. Table 1 presents the results for the four sample species collected from the bioreactor and corresponding reference plants. The results confirm that all species, except “water hemp” (Amarantus spp.) provide 13C ratios typical of C3 plants. Water hemp, a C4 plant, possesses less negative values characteristic of a plant that photosynthesizes by the C4 pathway. Thus, these results are consistent. The delta 15N (15N) values for all samples were less than 2.1%, with the exception of velvet leaf stem. Thus, all samples secured from the bioreactor were substantially less positive than the single soil sample from this same tank (7.3%). In contrast, nearly all reference samples were more positive than 4.0%. The only reference soil sample was soil collected from the immediate vicinity of the roots. Its 15N value as 0.6%. Plants growing in this medium do not exhibit depleted 15N values relative to a potential source for nitrogen. Lower delta 15N value correlates to nitrogen fixation.

### Methods

Leaf, stem, and root samples were taken from each variety of plant, as well as nightshade berries and velvet leaf pods. The plants were uprooted from the soft peat, and the leaves, stems, and roots were trimmed from the larger plants and collected in labeled bags. The specimens were transferred to a cooler at 4° C. and stored. The specimens were prepared for analysis after three weeks. A small section cut from the larger stem and root samples was analyzed, as were whole leaves, berries, and pods. The samples were ground in a blender and stored in scintillation vials to be transported for analysis. Samples were also taken from plants of the same species grown in soil located outside of the bioreactor. These were used as reference plants for isotopic analysis. A root sample was taken from the reference cottonwood tree. These samples were collected and prepared using the same methods described above.

TABLE 1
Enhanced growth in exemplary subject plant species

| | Original | Sample wt | δ¹⁵N_{AIR} | δ¹³C_{VPDB} | | | |
|---|---|---|---|---|---|---|---|
| SIRFER # | ID | (mg) | (‰) | (‰) | Wt % N | Wt % C | % C:% N ratio |
| Tank 8 Cottonwood lf | AB-1 | 0.760 | 2.0 | −32.1 | 2.8 | 47.8 | 16.8 |
| Cottonwood stem | AB-2 | 0.795 | −1.6 | −31.2 | 1.1 | 44.5 | 42.2 |
| Bl Nightshade stem | AB-3 | 0.754 | 1.5 | −28.8 | 1.3 | 42.7 | 32.1 |
| Bl Nightshade leaf | AB-4 | 0.799 | −0.9 | −27.9 | 1.1 | 44.9 | 40.4 |
| Bl Nightshade berry | AB-5 | 0.757 | 2.1 | −27.7 | 4.4 | 48.5 | 10.9 |
| Bl Nightshade berry | AB-6 | 0.772 | 0.1 | −25.9 | 2.2 | 48.7 | 22.1 |
| Velvet Leaf root | AB-7 | 0.782 | 1.6 | −32.0 | 0.5 | 45.7 | 86.0 |
| Velvet Leaf stem | AB-8 | 0.740 | 3.6 | −29.0 | 0.6 | 45.0 | 76.0 |
| Velvet Leaf pods | AB-9 | 0.752 | 1.4 | −27.0 | 3.3 | 47.2 | 14.5 |
| Water Hemp stem | AB-10 | 0.748 | 2.1 | −15.0 | 1.4 | 40.1 | 28.8 |
| Water Hemp leaf | AB-11 | 0.758 | 1.5 | −19.6 | 2.5 | 43.5 | 17.4 |
| Water Hemp root | AB-12 | 0.767 | 1.8 | −13.2 | 2.1 | 38.5 | 18.6 |
| Water Hemp root | ABR-1 | 0.759 | 4.3 | −11.9 | 0.4 | 39.0 | 100.5 |
| Water Hemp stem | ABR-2 | 0.760 | | −13.4 | | 45.2 | |
| Water Hemp leaf | ABR-3 | 0.745 | 4.7 | −14.0 | 2.4 | 42.1 | 17.3 |
| Velvet Leaf root | ABR-4 | 0.752 | 4.6 | −27.2 | 0.8 | 43.2 | 55.3 |
| Velvet Leaf stem | ABR-5 | 0.704 | 3.9 | −28.6 | 0.6 | 44.5 | 72.2 |
| Velvet Leaf pods | ABR-5 | 0.744 | 4.6 | −28.6 | 0.6 | 44.7 | 75.5 |
| Velvet leaf pod | ABR-6 | 0.751 | 4.5 | −28.4 | 2.0 | 47.7 | 24.2 |
| Cottonwood root | ABR-7 | 0.753 | 5.2 | −28.7 | 0.7 | 39.7 | 56.4 |
| Cottonwood stem | ABR-8 | 0.752 | 4.6 | −30.1 | 0.6 | 47.3 | 75.3 |
| Cottonwood leaf | ABR-9 | 0.759 | 5.6 | −29.7 | 2.6 | 47.9 | 18.1 |
| Black Nightshade root | ABR-10 | 0.750 | 2.0 | −27.8 | 1.5 | 38.6 | 26.5 |
| Black Nightshade st | ABR-11 | 0.750 | 7.1 | −29.5 | 1.9 | 41.4 | 21.7 |
| Black Nightshade lf | ABR-12 | 0.762 | 6.8 | −29.9 | 4.4 | 42.5 | 9.6 |
| Black Nightshade Berry | ABR-13 | 0.750 | 5.5 | −29.1 | 2.3 | 43.1 | 18.8 |
| | | Sample wt | δ¹⁵N_{AIR} | δ¹³C_{VPDB} | | | |
| Quality Assurance | Sample ID | (mg) | (‰) | (‰) | Wt % N | Wt % C | % C:% N ratio |
| PLRM-1 | UU-CN-1 | 0.5 | 49.8 | 24.1 | 10.4 | 45.3 | 4.4 |
| δ¹³C_{VPDB} = +23.96‰ | UU-CN-1 | 0.5 | 49.5 | 23.9 | 10.1 | 43.7 | 4.3 |
| δ¹⁵N_{AIR} = +49.63‰ | UU-CN-1 | 0.5 | | 23.9 | 10.4 | 44.0 | 4.2 |
| Average | | | 49.6 | 24.0 | 10.3 | 44.3 | |
| standard uncertainty | | | 0.2 | 0.1 | 0.1 | 0.9 | |
| | | Sample wt | δ¹⁵N_{AIR} | δ¹³C_{VPDB} | | | |
| | Sample ID | (mg) | (‰) | (‰) | Wt % N | Wt % C | % C:% N ratio |
| PLRM-2 | UU-CN-2 | 0.5 | −4.6 | −28.1 | 9.0 | 39.5 | 4.4 |
| δ¹³C_{VPDB} = −28.18‰ | UU-CN-2 | 0.5 | −4.7 | −28.2 | 9.0 | 39.4 | 4.3 |
| δ¹⁵N_{AIR} = −4.56‰ | UU-CN-2 | 0.5 | −4.5 | −28.2 | 9.6 | 39.6 | 4.1 |
| Average | | | −4.6 | −28.2 | 9.2 | 39.5 | |
| standard uncertainty | | | 0.1 | 0.0 | 0.3 | 0.1 | |
| | | Sample wt | δ¹⁵N_{AIR} | δ¹³C_{VPDB} | | | |
| Quality Control | Sample ID | (mg) | (‰) | (‰) | Wt % N | Wt % C | % C:% N ratio |
| SLRM | SPINACH | 0.7 | −0.3 | −27.5 | 5.7 | 39.4 | 6.9 |
| δ¹³C_{VPDB} = −27.41‰ | SPINACH | 0.7 | −0.2 | −27.5 | 5.9 | 39.4 | 6.7 |
| δ¹⁵N_{AIR} = −0.4‰ | SPINACH | 0.7 | −0.1 | −27.4 | 6.0 | 39.4 | 6.6 |
| average | | | −0.2 | −27.5 | 5.8 | 39.4 | |
| standard uncertainty | | | 0.1 | 0.0 | 0.2 | 0.0 | |
| acceptable range | | δ¹³C_{VPDB} | | | | | |
| 1 sigma = 0.2 | | | | | | | |
| acceptable range | | δ¹⁵N_{AIR} | | | | | |
| 1 sigma = 0.2 | | | | | | | |

### Example 2—Characterization of Endophytic Bacteria

Siderophore production, nitrogen fixation, phosphate solubilization, 1-aminocyclopropane-1-carboxylate (ACC) deaminase activity, and indole-3-acetic acid (IAA) determination were analyzed in 14 endophytic bacteria obtained from five aquatic plant sources and one terrestrial plant source (see Table 2). The accumulated characterization results of the endophytic bacteria isolates are illustrated in Table 2.

### Methods and Characterization

Plant samples were externally sterilized to allow for endophytic bacteria isolation. Sterilization was attained by soaking each plant sample in distilled water for 3 minutes, 95% alcohol for 30 seconds, 3% NaCl for 3 minutes, and then washed with distilled water 8 times. After sterilization each sample was placed in a sterile dish containing 1 ml of water and thoroughly crushed with a flat blade. Once a slurry was attained, the slurry was streaked on AK Agar using a sterile inoculation loop. Plates were incubated at 28° C. for 4 days. Individual colonies were then collected from the plates to inoculate tryptic soy broth. Broth was allowed to incubate overnight at 28° C. New AK Agar plates were streaked from the broth. Isolation was repeated 5 times until a visual assurance of single colony isolation was met. Plates containing an isolate microbe were then packaged and shipped for sequencing.

Siderophore production was determined by standard methods. 1 μl of pure bacterial culture grown in LB media was inoculation loop streaked onto Chrome Azurol S (CAS) plates. Plates were then incubated at 30° C. for 3 days, being observed daily for orange color formation around each colony. Experiments were performed in triplicate.

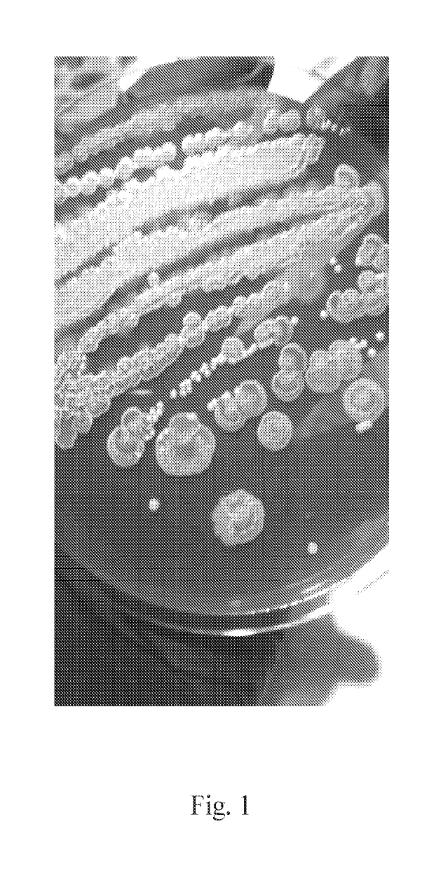

Nitrogen fixation was determined by standard methods. 1 μl of pure bacterial culture grown in LB media was inoculation loop streaked onto NFb plates with or without NH4Cl as the exclusive nitrogen source. Indicators for pH were added to each plate to ease visual differentiation. Plates were incubated at 28° C. for 7 days being observed daily for bacterial growth. Experiments were performed in triplicate (See FIG. 1).

Phosphate solubilization was determined by standard methods. 1 μl of bacterial culture grown in LB media was inoculation loop streaked onto trypticase soy agar (TSA) plates. Plates were then incubated at 30° C. for 7 days, being observed daily for transparent halo formation around each colony. Experiments were performed in triplicate.

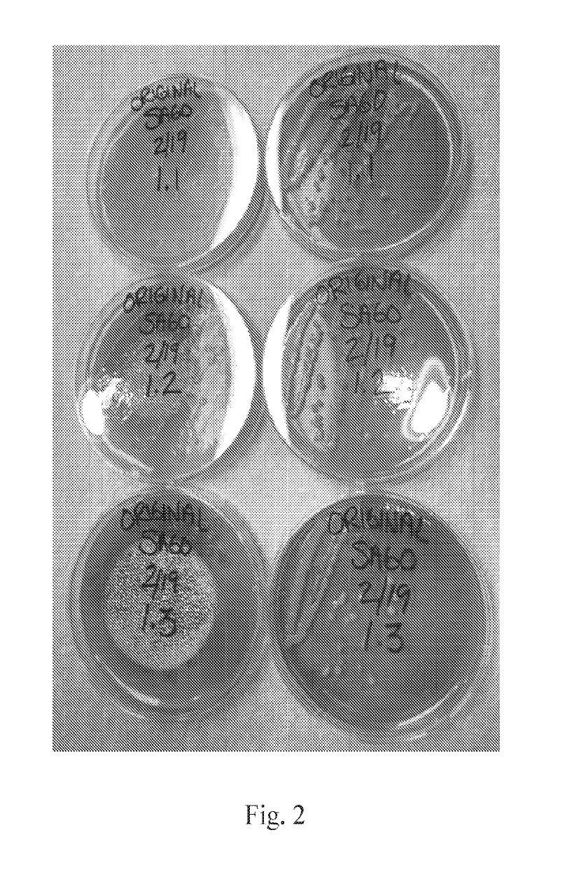

ACC deaminase activity was determined by standard methods. 1 μl of bacterial culture grown in LB media was inoculation loop streaked onto NFb plates with or without the addition of ACC streaked uniformly over the plate prior. Plates were colored with a pH indicator to aid in differentiation. Plates were then incubated at 28° C. for 4 days being observed daily for colony formation. Experiments were performed in triplicate (See FIG. 2).

IBA and IAA phytohormone production by the isolated microbes was determined by standard methods. For example, Salkowski reagent was prepared by mixing 2 ml of 0.5 M FeCl3, 49 ml of 70% perchloric acid, and 49 ml of deionized water. Yeast Mannitol Broth (YMB) without tryptophan was used as the growth media The YMB media was prepared according to protocol 12.7 g/L in warm water, and allowed to cool to room temperature. All strains 100 μL each, were incubated in 5 mL of YMB at room temperature with continuous shaking for five days. After 5 days of growth, the culture supernatants were recovered after centrifugation at 3200 rpm for 10 minutes. One milliliter of the supernatant was mixed with 2 mL of Salkowski reagent. The mixture was allowed to stand for 30 minutes. This experiment was repeated for validation. In the second experiment, the microbial growth was done for two weeks at the same conditions as initially stated.

Gibberellic acid (GA3) production by the isolated microbes was determined using a Professional 850 Ion Chromatography system with a conductivity detector. The mobile phases were 3.2 mM Sodium Carbonate/1.0 mM Sodium Bicarbonate and 1.75 mM Nitric Acid/0.75 mM Dipicolinic Acid. The columns were Metrosep A Supp 5-100/4.0, 5 μm particle size for the anion separation and Metrosep C4—100/4.0, 5 μm particle size for the cation separation. The anion column was fitted with a Metrosep A Supp 4/5 Guard 4.0 precolumn guard cartridge and the cation column was fitted with a Metrosep C 4 Guard/4.0 precolumn guard cartridge. Column temperatures were set at 25° C. with a flow rate of 0.7 mL/min for the anion column and 0.9 mL/min for the column. Injection volume for both columns was 20 μL. A 100 mM sulfuric acid solution was used as the regenerant for the anion suppressor module. The gibberellic acid standard solution used in this analysis for validation was 13 mg/mL GA3 purchased from phyto Technology Laboratories. A measured amount of 20 μL of each of the 14 isolated microbes was added to 40 mL of Yeast Mannitol Broth (YMB) and incubated for 14 days at room temperature on a shaker. The YMB does not contain tryptophan. After the incubation period, 10 mL of each sample was measured into a 15 mL centrifuge tube and centrifuged for 10 minutes at 3200 rpm. Each supernatant was filtered through a 2-μm nylon filter, 0.5 mL measured into IC vials, and diluted to a final volume of 12 mL for analysis using ultrapure water. REL-AT1122, RAJ-AT5256, AKA-AT1212, and AKO-AT2016 did not produce gibberellic acid during the 14 days incubation period. The rest produced significant amount of gibberellic acid.

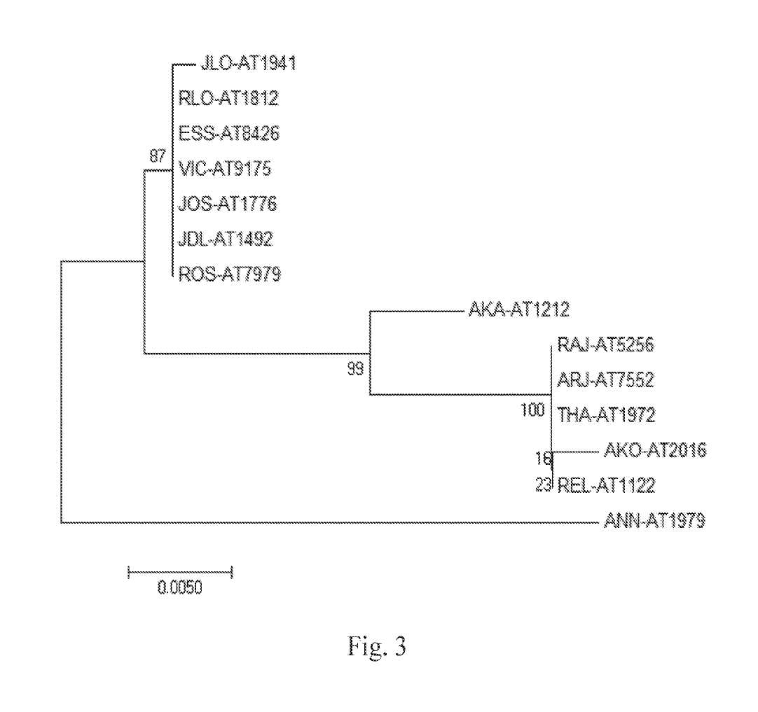

A total of 14 endophytic isolates were further evaluated. The evolutionary history was inferred using the Neighbor-Joining method. The optimal tree with the sum of branch length=0.05904019 is illustrated by FIG. 3. The percentage of replicate trees in which the associated taxa clustered together in the bootstrap test (1000 replicates) is indicated next to the branches. The tree is drawn to scale, with branch lengths in the same units as those of the evolutionary distances used to infer the phylogenic tree. The evolutionary distances were computed using the Kimura 2-parameter method and are in the units of the number of base substitutions per site. The analysis involved 14 nucleotide sequences. Codon positions included were nucleotide sequences 1st+2nd+3rd+Noncoding. All positions containing gaps and missing data were eliminated. There were a total of 910 positions in the final dataset. Evolutionary analyses were concluded in MEGA7.

Cell morphology and topographic gram stain indicated 100% gram positive bacilli. The isolates were evaluated in vitro based upon growth on nitrogen-free medium, phosphate solubilization in agar plate, and Siderophore production in defined medium. All 14 isolates demonstrated an ability to grow in nitrogen-free conditions. All 14 isolates resulted with orange color formation around each colony, indicating siderophore production. ACC deaminase activity on agar plate was present in all 14 tested isolates.

TABLE 2
Characterization of endophytic bacteria strain isolates.

| | | | | | | ACC | | | |
|---|---|---|---|---|---|---|---|---|---|
| | Sample | | Siderophore | Nitrogen | Phosphate | Deaminase | IAA | IBA | GA3 |
| Strain Name | Origination | Gram Stain | Production | Fixation | Solubilization | Activity | Production | Production | Production |
| JDL-AT1492 | Microbe | + | + | + | + | + | + | + | + |
| | (isolated from cloudy | | | | | | | | |
| | stock water) #1 | | | | | | | | |
| JOS-AT1776 | Microbe | + | + | + | + | + | + | + | + |
| | (isolated from cloudy | | | | | | | | |
| | stock water) #2 | | | | | | | | |
| JLO-AT1941 | Microbe | + | + | + | + | + | + | + | + |
| | (isolated from cloudy | | | | | | | | |
| | stock water) #3 | | | | | | | | |
| REL-AT1122 | Velvet Leaf(pulled from | + | + | + | + | + | + | + | − |
| | tank bioreactor) #1 | | | | | | | | |
| ROS-AT7979 | Velvet Leaf | + | + | + | + | + | + | + | + |
| | (pulled from tank | | | | | | | | |
| | bioreactor) #2 | | | | | | | | |
| RLO-AT1812 | Velvet Leaf | + | + | + | + | + | + | + | + |
| | (pulled from tank 8 | | | | | | | | |
| | bioreactor) #3 | | | | | | | | |
| RAJ-AT5256 | Original Sago pondweed | + | + | + | + | + | + | + | − |
| | (tubed stock culture) #1 | | | | | | | | |
| ARJ-AT7552 | Original Sago pondweed | + | + | + | + | + | + | + | + |
| | (tubed stock culture) #2 | | | | | | | | |
| THA-AT1972 | Sago pondweed tuber | + | + | + | + | + | − | − | + |
| | (pulled from tank 6 | | | | | | | | |
| | bioreactor) | | | | | | | | |
| ANN-AT1979 | FarmingtonBay Sago | + | + | + | + | + | + | + | + |
| | pondweed | | | | | | | | |
| | (tubed stock culture) #1 | | | | | | | | |
| AKA-AT1212 | Farmington Bay Sago | + | + | + | + | + | + | + | − |
| | pondweed | | | | | | | | |
| | (tubed stock culture) #2 | | | | | | | | |
| AKO-AT2016 | Farmington Bay Sago | + | + | + | + | + | − | − | − |
| | pondweed | | | | | | | | |
| | (tubed stock culture) #3 | | | | | | | | |
| VIC-AT9175 | Duckweed (pulled from | + | + | + | + | + | + | + | + |
| | tank 6 bioreactor) #1 | | | | | | | | |
| ESS-AT8426 | Duckweed | + | + | + | + | + | + | + | + |
| | (pulled from tank 6 | | | | | | | | |
| | bioreactor) #2 | | | | | | | | |

### Example 3—Bacterial Taxa Identification

A study was performed to identify endophytic bacterial taxa present in different plant matter isolates. Endophytic bacterial taxa from plant samples taken from 6 different source sites were identified. 16S rDNA sequences indicated that the isolated microbes are members of the Bacillus genus of Gram-positive bacteria. Samples had a high similarity (96-99%) to the Bacillus subtilis group. This group includes Bacillus subtilis, Bacillus licheniformis. Bacillus amyloliquefaciens. Bacillus atrophaeus. Bacillus mojavensis. Bacillus vallismortis, and Bacillus sonorensis.

Sequencing resulted in the identification of strains identified in Table 3 below.

TABLE 3
Exemplary species

| B. pumilus | B. amyloliquefaciens | B. licheniformis |
|---|---|---|
| AKA-AT1212 | ANN-AT1979 | JDL-AT1492 |
| RAJ-AT5256 | AKO-AT2016 | JLO-AT1941 |
| ARJ-AT7552 | JOS-AT1776 | VIC-AT9175 |
| REL-AT1122 | THA-AT1972 | ESS-AT8426 |
| ROS-AT7979 | | |
| RLO-AT1812 | | |

### Methods

Plant samples were externally sterilized for endophytic isolation. Sterilization was attained by soaking each plant sample in distilled water for 3 minutes, 95% alcohol for 30 seconds, 3% NaCl for 3 minutes, and then washed with distilled water 8 times. After sterilization, each sample was thoroughly crushed in a sterile dish containing 1 ml of water. Once a slurry was attained, this was streaked on AK Agar using a sterile loop. Plates were incubated at 28° C. for 4 days. Individual colonies were then pulled from the plates to inoculate tryptic soy broth. Broth was allowed to incubate overnight at 28° C. New AK Agar plates were streaked from the broth. Isolation was repeated 5 times until visual assurance of single colony isolation was met. Plates containing an isolated microbe were then packaged and shipped for sequencing.

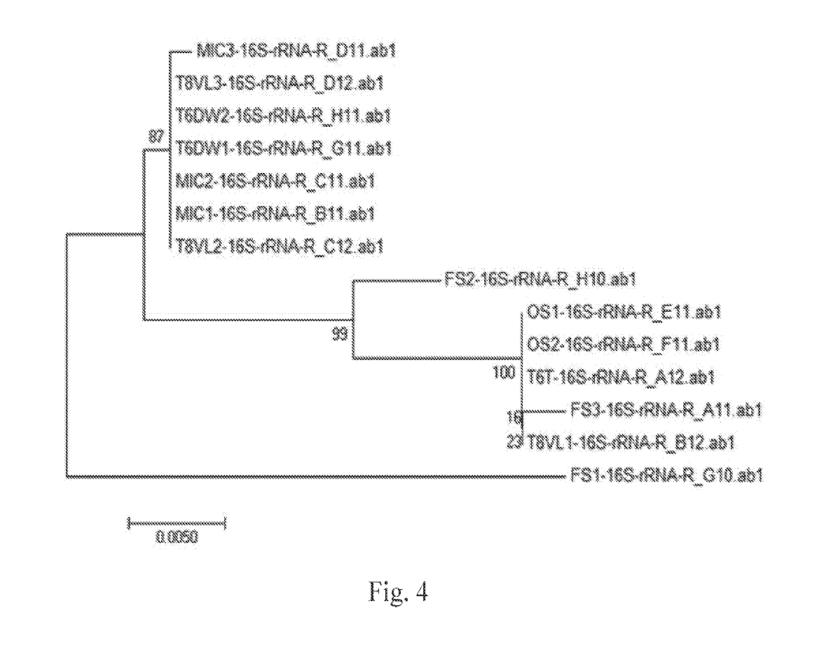

A phylogenetic tree was created using the Molecular Evolutionary Genetics Analysis (MEGA) tool (FIG. 4). The evolutionary history was inferred using the Neighbor-Joining method. The optimal tree with the sum of branch length=0.05904019 is depicted (FIG. 4). The percentage of replicate trees in which the associated taxa clustered together in the bootstrap test (1000 replicates) is indicated next to the branches. The tree is drawn to scale, with branch lengths in the same units as those of the evolutionary distances used to infer the phylogenetic tree. The evolutionary distances were computed using the Kimura 2-parameter method and are in the units of the number of base substitutions per site. The analysis involved 14 nucleotide sequences. Codon positions included were 1st+2nd+3rd+Noncoding. All positions containing gaps and missing data were eliminated. There were a total of 910 positions in the final dataset. Evolutionary analyses were conducted in MEGA7.

Plates with microbe isolates were sequenced by whole-genome sequencing as well as sequencing of the 16S rRNA gene. Data was converted from FASTQ to FASTA format for use with the National Center for Biotechnology Information (NCBI) Basic Local Alignment Search Tool (BLAST) program. Each sequence was searched against a microbe genome database in order to identify the species.

### Example 4—Enhanced Growth/Productivity in Various Crops

### Wheat

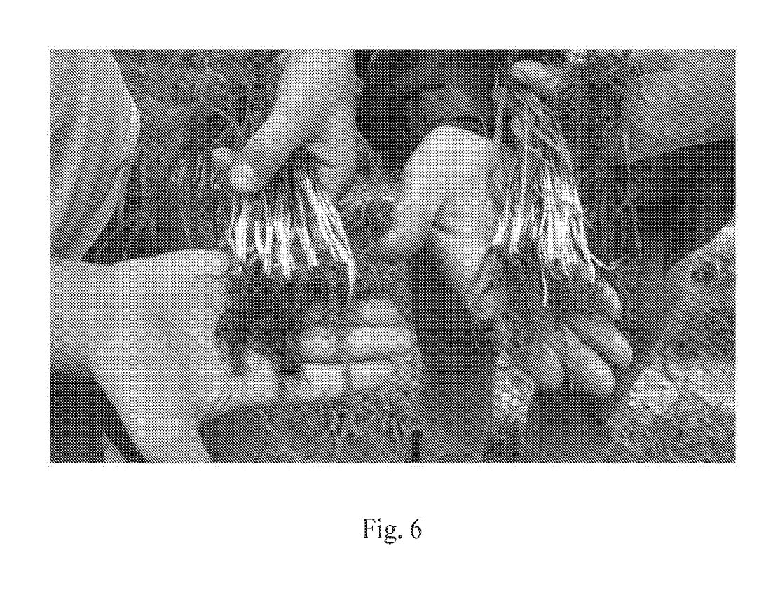

In an exemplary method, wheat seed was coated with a formulation of a plant growth enhancer described herein. The formulation was applied with a sugar water adhering agent, or seed was first coated in a sugar water mixture and then coated with the plant growth enhancer. Control rows of untreated seed were planted on either side of sections of rows where treated seeds were planted in order to visually determine whether nearby untreated rows demonstrate improved growth and how far away from the row of treated seeds any improved growth occurs. Visible improvement in early growth was observed (FIG. 6). The treated crops had a more lush appearance due to deeper green tone of the individual blades, greater visible general size and denser growth.

Little to no difference in weed growth was observed near rows of treated seed relative to rows of control seed. Both control and treated seed areas had roughly equal amounts of weed growth, and none appeared to have any greater weed growth than the others.

Fifteen samples of wheat were examined from both the control and the treated plants through random sample site selection. Greater dry weight mass was observed in the treated wheat samples early in the growing cycle (see Table 4).

TABLE 4
Dry mass weights from treated and untreated wheat seed
Wheat - seed coated trial
Sampled near Leola, SD on May 20, 2016
dry weight (g)

| Untreated | Treated |
|---|---|
| 0.3573 | 0.2939 |
| 0.3263 | 0.2545 |
| 0.2802 | 0.3949 |
| 0.2266 | 0.3115 |
| 0.344 | 0.307 |
| 0.3144 | 0.3387 |
| 0.2467 | 0.3565 |
| 0.2796 | 0.1949 |
| 0.0878 | 0.3045 |
| 0.3651 | 0.1684 |
| 0.2992 | 0.4572 |
| 0.3058 | 0.3174 |
| 0.1779 | 0.3039 |
| 0.3623 | 0.1273 |
| 0.2585 | 0.4185 |
| Untreated mean: | 0.2821 |
| Treated mean: | 0.3033 |

Both dry weight and wet weight values were also increased in treated plants early in the growing season. Head weight was particularly enhanced in treated wheat plants. Overall, treated wheat grew more quickly than control wheat.

Treated wheat felt sturdier, had an overall healthier appearance, and had an observed higher plant density relative to controls.

Nutritional analysis revealed an overall positive trend in nutritional content in treated wheat, as measured in percent by weight. Overall increases were observed in, for example, calcium, iron, potassium, phosphorus, magnesium, and sulfur.

### Alfalfa

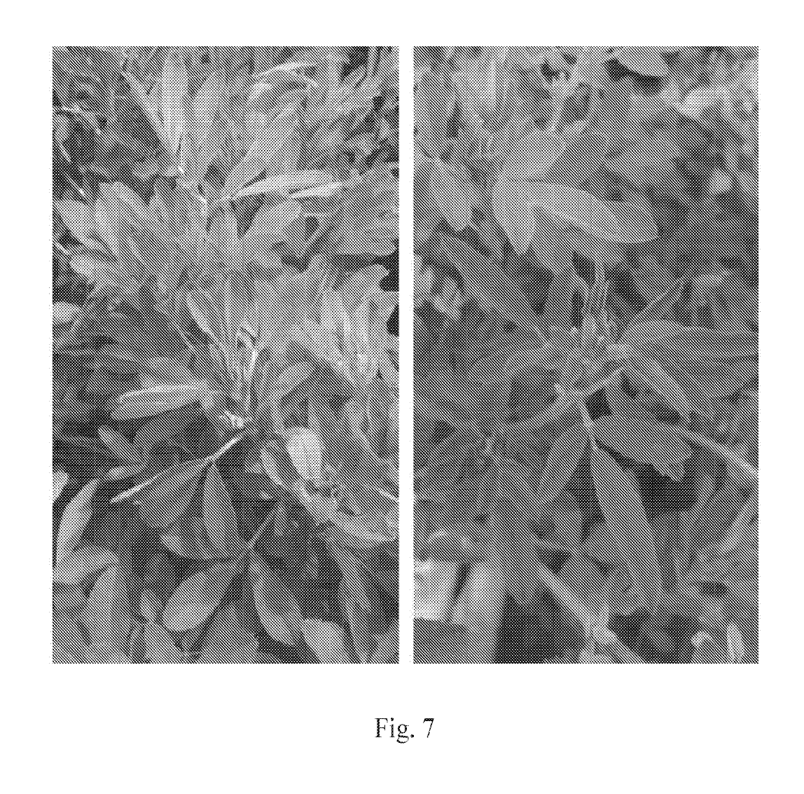

In another exemplary method, alfalfa was either treated with a formulation of a plant growth enhancer of the present disclosure via foliar application after initial growth was achieved, or left alone without treatment to act as a control. Crops are planted in fields utilizing pivot irrigation. Data was collected following a first cutting of a 5-cut system. Data indicate a notable 13.5% increase in tonnage (see FIG. 7), with no negative impact on feed value. Protein values were 22.5 in the treated crop and 21.8 in control, with a reclaimed feed value of 168 in treated crop and 159 in control. The forage NIR analysis report is presented in Table 5. Stress blossoming was observed in the control set but not in the treatment crop (see Table 5). Additional time prior to blossoming can extend the vegetative growth stage and thus maintain feed value, leading to an increased tonnage (See Table 5).

TABLE 5
Data from foliar application on Alfalfa
Alfalfa - foliar trial
Sampled near Buhl, ID on May 18, 2016
Green chop

| | Untreated (as | Untreated (dry | Treated (as | Treated (dry |
|---|---|---|---|---|
| Components | sampled basis) | matter basis) | sampled basis) | matter basis) |
| % Moisture | 80.90 | | 81.00 | |
| % Dry matter | 19.10 | | 19.00 | |
| % Crude protein | 4.00 | 21.10 | 4.30 | 22.50 |
| Soluble protein % | | 45.00 | | 47.00 |
| % ADICP | 0.30 | 160 | 0.30 | 1.50 |
| % NDICP | 0.80 | 4.10 | 0.70 | 3.90 |
| % Acid detergent fiber | 6.20 | 32.50 | 6.00 | 31.70 |
| % Neutral detergent fiber | 7.80 | 41180 | 7.70 | 40.413 |
| % Lignin | 1.50 | 7.80 | 1.40 | 7.40 |
| % Ash | 2.00 | 10.45 | 2.04 | 10.75 |
| % Crude fat | 0.40 | 2.30 | 0.40 | 2.10 |
| % Water soluble carb. | 1.60 | 8.20 | 1.80 | 930 |
| % Starch | 0.40 | 2.10 | 0.40 | 1.90 |
| kd %/hr | | 12.59 | | 8.74 |
| % Calcium | 0.23 | 1.19 | 0.22 | 1.19 |
| % Phosphorus | 0.06 | 0.32 | 0.07 | 035 |
| % Magnesium | 0.06 | 0.29 | 0.05 | 029 |
| % Potassium | 0.54 | 2.82 | 0.56 | 2.97 |
| % Sulfur | 0.04 | 0.20 | 0.04 | 0.20 |
| % Chloride | 0.17 | 0.87 | 0.19 | 0.99 |
| PITD 24 hr % of DM | | 81.00 | | 83.00 |
| NDFD 24 hr % of NDF | | 54.00 | | 57.00 |
| NDFD 30 hr % of NDF | | 55.00 | | 59.00 |
| ADICP % CP | | 7.60 | | 5.70 |
| NDICP % CP | | 19.40 | | 17.20 |
| Lignin % NDF | | 19.00 | | 18.40 |
| Degradable protein % CP | | 70.00 | | 72.00 |
| % ESC (simple sugars) | 1.50 | 7.70 | 1.50 | 7.90 |
| % NFC | 5.60 | 29.40 | 5.30 | 28.10 |
| % TDN | 11.00 | 58.00 | 11.00 | 58.00 |
| CA 90% TDN | 52.00 | | 53.00 | |
| NEL lx, Mcal/1b | 0.12 | 0.65 | 0.12 | 0.55 |
| NEL 3x, Mcal/1b | 0.12 | 0.60 | 0.11 | 0.60 |
| NEM Mcal/1b | 0.10 | 0.55 | 0.10 | 0.54 |
| NEG, Mcal/1b | 0.06 | 0.29 | 0.05 | 0.29 |
| Relative feed value | | 145.00 | | 148.00 |
| RFQ 48 | | 159.00 | | 157.00 |

### Potato

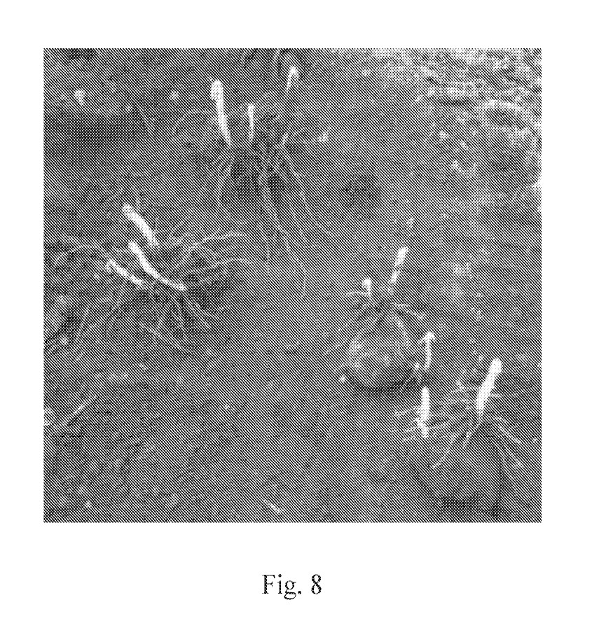

In another exemplary method, potatoes were either coated with a plant growth enhancer composition described herein prior to planting or left untreated to act as a control. Seed potatoes were cut in half, maintaining at least one “eye” growth point on each, rolled in the plant growth enhancer, and then planted in a field with irrigation. At 21 days post planting, samples were dug up to verify growth in both the control and experimental sets. Treated potatoes displayed much greater root development (FIG. 8).

### Triticale

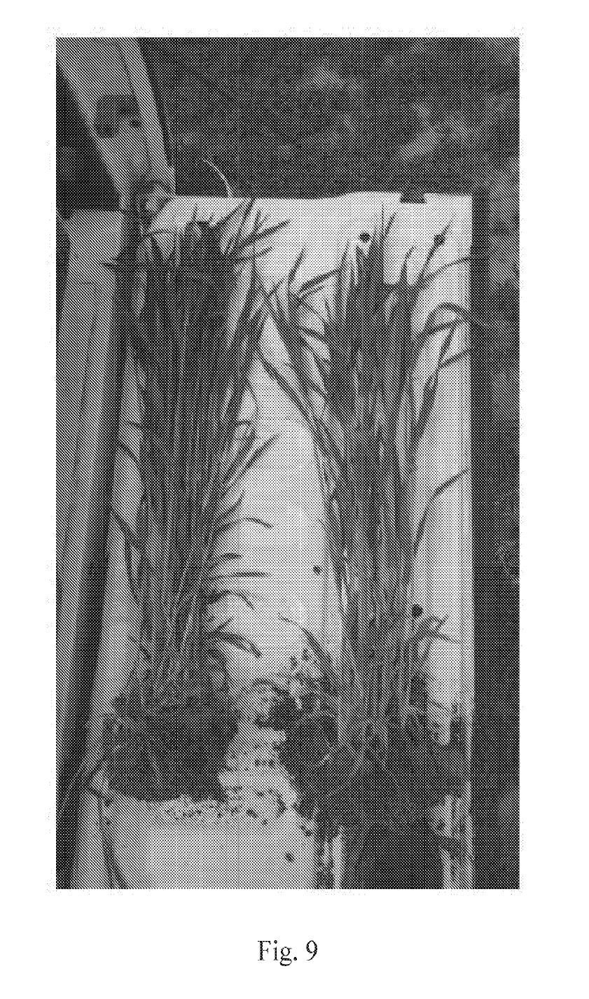

In yet another exemplary method, triticale was either treated with a plant growth enhancer of the present disclosure via foliar application after the initial growth stage had been reached, or left untreated to act as a control set. An average 16% increase in yield was determined by total weight after 3 cuts (see FIG. 9).

### Tomato

In one exemplary method, tomatoes were being grown in hoop-houses where an experimental set was treated with a plant growth enhancer of the present disclosure via foliar application after initial growth stage had been reached, or left untreated to act as a control. Analysis indicated 35% greater blooms on the experimental set as opposed to the control set.

### Corn

In another exemplary experiment, corn was either coated with a plant growth enhancer of the present disclosure prior to planting, or left untreated to act as a control. A sample set of 10 plants from both treated and untreated corn in the field were sent for measurement and analysis. Plants were weighed for wet weight, measured for stalk girth using a caliper, nodal roots were counted, and plants were dried and measured to attain a final dry weight. The treated plants exhibited an increase in stalk girth width, a generally higher v-stage, a higher number of nodal root development, wet weight, and higher dry weight. Relative to control plants, treated plants had 26.67% greater wet weight, a 23.47% greater dry weight for roots, a 41.15% greater dry weight for above ground stems, and a 33.43% greater dry weight for the whole plant (see Table 6). The higher v-stage may account for the higher root development among the treated plants.

TABLE 6
Data from corn seed-coat trial
Corn-seed coat trial
Located near Buhl, ID on May 25, 2016

| | | | | | | | Dry |
|---|---|---|---|---|---|---|---|
| | Girth | | | | | | weight |
| | of | | Nodal | Wet | Dry | Dry | whole |
| | stalk | Leaf | root | weight | weight | weight | plant |
| | (cm) | stage | number | (g) | root (g) | stem (g) | (g) |
| Untreated | | | | | | | |
| samples | | | | | | | |
| 1 | 0.629 | v2 | 3 | 3.955 | 0.312 | 0.259 | 0.571 |
| 2 | 0.838 | v2 | 6 | 5.825 | 0.339 | 0.418 | 0.757 |
| 3 | 0.711 | v2 | 3 | 3.951 | 0.245 | 0.291 | 0.536 |
| 4 | 0.792 | v2 | 4 | 4.469 | 0.366 | 0.313 | 0.679 |
| 5 | 0.688 | v2 | 6 | 5.203 | 0.36 | 0.372 | 0.732 |
| 6 | 0.604 | v3 | 5 | 2.752 | 0.195 | 0.218 | 0.413 |
| 7 | 0.787 | v2 | 5 | 4.845 | 0.261 | 0.39 | 0.651 |
| 8 | 0.462 | v2 | 3 | 2.795 | 0.238 | 0.172 | 0.41 |
| 9 | 0.751 | v3 | 6 | 4.331 | 0.389 | 0.288 | 0.677 |
| 10 | 0.749 | v2 | 6 | 4.91 | 0.412 | 0.37 | 0.782 |
| Means | 0.701 | 2.2 | 4.7 | 4.304 | 0.312 | 0.309 | 0.621 |
| Treated | | | | | | | |
| samples | | | | | | | |
| 1 | 0.939 | v3 | 9 | 5.381 | 0.36 | 0.425 | 0.785 |
| 2 | 0.896 | v3 | 9 | 7.402 | 0.462 | 0.737 | 1.199 |
| 3 | 0.754 | v2 | 6 | 5.442 | 0.313 | 0.328 | 0.641 |
| 4 | 0.848 | v3 | 7 | 6.113 | 0.449 | 0.536 | 0.985 |
| 5 | 0.871 | v3 | 7 | 4.605 | 0.235 | 0.362 | 0.597 |
| 6 | 0.769 | v2 | 5 | 5.466 | 0.488 | 0.347 | 0.835 |
| 7 | 0.726 | v2 | 3 | 4.604 | 0.381 | 0.311 | 0.692 |
| 8 | 0.901 | v3 | 6 | 6.64 | 0.423 | 0.825 | 1.248 |
| 9 | 0.820 | v2 | 6 | 5.979 | 0.424 | 0.654 | 1.078 |
| 10 | 0.977 | v3 | 6 | 7.057 | 0.538 | 0.728 | 1.266 |
| Means | 0.850 | 2.6 | 6.4 | 5.869 | 0.407 | 0.525 | 0.933 |
| Percentage | | | | 26.67% | 23.47% | 41.15% | 33.43% |
| change | | | | | | | |

### Soybean

In another exemplary method, soybean seed was coated with a formulation of a plant growth enhancer described herein. The formulation was applied with a sugar water adhering agent. Control rows of untreated seed were planted on either side of rows of treated seeds. The rows were observed to determine whether treated seed resulted in improved growth, and how far away from the row of treated seeds any improved growth occurs. Visible improvement in early growth was observed, as was accelerated plant maturation in certain field tests.

Ten samples of soybean were examined from both the control and the treated plants through random sample site selection, per the study by Purdue University. (Casteel, Shaun. N. (2012, Aug. 14). Estimating Soybean Yields—Simplified. Retrieved from https://www.angry.purdue.edu/ext/soybean/News/2012/2012_0814SOYSimplifiedYieldEstimates.pdf). Greater dry weight mass, nodes, side notes, and pod count was observed in the treated samples early in the growing cycle, which appeared to mature at an earlier time than the control plants.

All of the COMPOSITIONS and METHODS disclosed and claimed herein can be made and executed without undue experimentation in light of the present disclosure. While the compositions and methods have been described in terms of preferred embodiments, it is apparent to those of skill in the art that variations maybe applied to the COMPOSITIONS and METHODS and in the steps or in the sequence of steps of the methods described herein without departing from the concept, spirit and scope herein. More specifically, certain agents that are both chemically and physiologically related may be substituted for the agents described herein while the same or similar results would be achieved. All such similar substitutes and modifications apparent to those skilled in the art are deemed to be within the spirit, scope and concept as defined by the appended claims.

1. A method for making a terrestrial plant growth enhancer, the method comprising:
growing one or more submersible aquatic plants in a growth substrate submersed in a liquid a media to produce a conditioned growth substrate and a conditioned liquid media,
collecting at least one of the conditioned growth substrate and the conditioned liquid media, and
drying the conditioned growth substrate and particulating the dried, conditioned growth substrate to produce a terrestrial plant growth enhancer from at least one of the dried conditioned growth substrate and the conditioned liquid media.

2. The method according to claim 1, further comprising mixing the terrestrial plant growth enhancer with at least one coating assist or at least one adhering agent.

3. The method according to claim 2, wherein the at least one coating assist comprises talc, graphite, or a combination thereof.

4. The method according to claim 2, wherein the at least one adhering agent comprises a sugar water mixture, a gum arabic, or a combination thereof.

5. The method according to claim 1, wherein particulating the dried, conditioned growth substrate comprises grinding, crushing, milling, or pulverizing the dried, conditioned growth substrate.

6. The method according to claim 1, wherein the particulated dried, conditioned growth substrate is formulated into a pellet.

7. The method according to claim 1, further comprising at least partially rehydrating the particulated dried, conditioned growth substrate.

8. The method according to claim 7, wherein the particulated dried, conditioned growth substrate is at least partially rehydrated with water.

9. The method according to claim 7, further comprising adding to an at least partially rehydrated particulated dried, conditioned growth substrate at least one of a bacterial germination stimulant, a carbon source, a polymer, an adhering agent, and a fertilizing agent.

10. The method according to claim 9, wherein the bacterial germination stimulant comprises at least one of gamma-aminobutyric acid (GABA) and monosodium glutamate (MSG), the carbon source comprises glycerol, and the adhering agent comprises a sugar.

11. The method according to claim 1, further comprising adding to the collected, conditioned liquid media at least one of a bacterial germination stimulant, a carbon source, a polymer, and a fertilizing agent.

12. The method according to claim 11, wherein the bacterial germination stimulant comprises at least one of gamma-aminobutyric acid and monosodium glutamate, and the carbon source comprises glycerol.

13. A method for treating a terrestrial plant, the method comprising:
performing the method according to claim 1, and
applying the conditioned liquid media to foliage of the terrestrial plant.

14. A method for treating a terrestrial plant, the method comprising:
performing the method according to claim 1, and
providing the conditioned liquid media to a field of terrestrial plants or a crop.

15. A method for making a terrestrial plant growth enhancer, the method comprising:
growing one or more submersible aquatic plants in a growth substrate to produce a conditioned growth substrate,
collecting the conditioned growth substrate,
fermenting the collected conditioned growth substrate, and
collecting a fermentation liquid, wherein the fermentation liquid is the terrestrial plant growth enhancer.

16. The method according to claim 15, further comprising drying and particulating the conditioned growth substrate prior to the fermentation step.

17. The method according to claim 16, wherein particulating the dried, conditioned growth substrate is done by grinding, crushing, milling, or pulverizing the dried, conditioned growth substrate.

18. The method according to claim 15, wherein the fermenting step comprises combining the conditioned growth substrate with water and at least one microbial nutrient source.

19. The method according to claim 18, wherein the at least one microbial nutrient source comprises sugar.

20. The method according to claim 19, wherein the sugar is cane sugar.

21. The method according to claim 15, further comprising adding acetic acid during the fermenting step.

22. The method according to claim 21, wherein the acetic acid is added as a solution from 2% to 10% acetic acid.

23. The method according to claim 15, further comprising fermenting the conditioned growth substrate in the presence of unchlorinated water.

24. The method according to claim 15, wherein fermenting comprises fermenting for at least 12 hours, at least 24 hours, at least 48 hours, or at least 96 hours.

25. The method according to claim 15, further comprising concentrating the fermentation liquid.

26. The method according to claim 25, wherein the fermentation liquid is concentrated by filtration, centrifugation, dehydration, or a combination thereof.

27. The method of claim 15, further comprising combining the terrestrial plant growth enhancer with a least one carbon source.

28. The method according to claim 27, wherein the at least one carbon source comprises glycerol.

29. The method according to claim 27, further comprising combining the terrestrial plant growth enhancer and the at least one carbon source with a polymer.

30. The method according to claim 15, further comprising applying the fermentation liquid to a carrier, drying the treated carrier, and particulating the dried, treated carrier to produce a concentrated terrestrial plant growth enhancer.

31. The method according to claim 30, wherein particulating the dried, treated carrier comprises grinding, crushing, milling, or pulverizing the dried, treated carrier.

32. The method according to claim 30, further comprising combining the concentrated terrestrial plant growth enhancer with at least one coating assist.

33. The method according to claim 28, wherein the at least one coating assist comprises talc, graphite, or a combination thereof.

34. The method according to claim 1, wherein the growth substrate comprises peat.

35. The method according to claim 1, wherein the one or more submersible aquatic plants are one or more members of the Potamogetonaceae family.

36. The method according to claim 35, wherein the one or more submersible aquatic plants of the Potamogetonaceae family are Stuckenia pectinata plants (sago pondweed).

37. A terrestrial plant growth enhancer produced by the method according to claim 1.

38. A method for treating a terrestrial plant seed, the method comprising first applying an adhering agent to the terrestrial plant seed and applying the terrestrial plant growth enhancer produced by the method according to claim 1 to the terrestrial plant seed to produce a treated terrestrial plant seed.

39. A method for treating a terrestrial plant, the method comprising providing a terrestrial plant growth enhancer produced by the method of claim 1 to the terrestrial plant.

40. A method for enhancing or accelerating growth in a terrestrial plant, the method comprising performing the method according to claim 38 and growing a plant from the treated terrestrial plant seed.

41. A method for enhancing growth in a terrestrial plant, the method comprising performing the method according to claim 39.

42. A composition for enhancing or accelerating growth of a terrestrial plant, the composition comprising:
a conditioned liquid media, wherein the conditioned liquid media was obtained from a submersible plant after a predetermined growth period; and
a peat-based mixture.

43. A composition for enhancing or accelerating growth of a terrestrial plant, the composition comprising a conditioned liquid media, wherein the conditioned liquid media was obtained from a submersible plant after a predetermined growth period.

44. A composition for enhancing or accelerating growth of a terrestrial plant, the composition comprising a conditioned growth substrate, wherein a growth substrate supported growth of one or more submersible plants for a sufficient growth period to produce the conditioned growth substrate.

45. The composition according to claim 44, further comprising a peat-based mixture.

46. The composition according to claim 42, wherein the composition further comprises at least one bacterial germination stimulant.

47. The composition according to claim 46, further comprising at least one adhesive agent.

48. The composition according to claim 42, wherein the composition comprises at least one species of plant growth promoting bacteria (PGPB).

49. The composition according to claim 48, wherein the at least one species of PGPB comprise Bacillus spp.

50. The composition according to claim 49, wherein the Bacillus spp. comprise one or more of Bacillus subtilis, Bacillus licheniformis, Bacillus amyloliquefaciens, Bacillus atrophaeus, Bacillus mojavensis, Bacillus vallismortis, and Bacillus sonorensis.

51. The composition according to claim 42, wherein the one or more submersible plants are Stuckenia pectinata plants (sago pondweed).

52. The composition according to claim 48, wherein the at least one species of PGPB are obtained from Stuckenia pectinata plants (sago pondweed).

53. The composition according to claim 42, wherein the peat-based mixture comprises peat exposed to Stuckenia pectinata plants (sago pondweed).

54. The composition according to claim 46, wherein the at least one bacterial germination stimulant comprises one or more of a saprophytic organism, gamma-aminobutyric acid and monosodium glutamate.

55. The composition according to claim 47, wherein the at least one adhesive agent comprises a sugar-based mixture.

56. The composition according to claim 42, wherein the composition is formulated for application to one or more tissues of the plant.

57. The composition according to claim 42, wherein the composition is formulated for application to one or more of the roots, seeds, and leaves of the terrestrial plant.

58. The composition according to claim 42, wherein the composition is formulated to cause endophytic population of one or more tissues of the terrestrial plant with a plant growth promoting bacteria.

59. The composition according to claim 42, wherein the composition further comprises a fertilizing agent.

60. The composition according to claim 59, wherein the fertilizing agent comprises an inorganic fertilizing agent comprising one or more of sodium nitrate, ammonium sulfate, and ammonium phosphate.

61. The composition according to claim 59, wherein the fertilizing agent comprises an organic fertilizing agent comprising one or more of manure, compost, and bone meal.

62. The composition according to claim 42, wherein the plant comprises one or more of wheat, triticale, corn, soybeans, alfalfa, sorghum, sugar beets, barley, oats, sunflowers, potatoes, carrots, triticale, fruit trees, pistachio trees, pecan trees, tomatoes, strawberries, raspberries green pepper, red kidney beans, okra, celery, lettuce, pansies and other horticultural species, nut-producing plants and horticultural trees.

63. The composition according to claim 42, wherein the composition promotes the growth of one or more tissues of the plant.

64. A method for enhancing or accelerating the growth of a plant, the method comprising:
providing the plant with a composition according to claim 42.

65. The method of claim 64, further comprising exposing the plant tissue to a peat-based mixture.

66. The method according to claim 64, further comprising exposing the plant to at least one bacterial germination stimulant.

67. The method according to claim 65, wherein the peat-based mixture comprises a peat growth medium conditioned by a sago pondweed.

68. The method according to claim 66, wherein the at least one bacterial germination stimulant comprises one or more of gamma-aminobutyric acid and monosodium glutamate.

69. The method according to claim 64, wherein the composition is applied to one or more of the roots, seeds, and leaves of the subject plant.

70. The method according to claim 64, wherein the plant is one or more of wheat, triticale, corn, soybeans, alfalfa, sorghum, sugar beets, barley, oats, sunflowers, potatoes, carrots, triticale, fruit trees, pistachio trees, pecan trees, alfalfa, hay, tomatoes, strawberries, raspberries green pepper, red kidney beans, okra, celery, lettuce, pansies and other horticultural species, nut-producing plants, and horticultural trees.

71. The method according to claim 64, wherein the composition promotes the growth of one or more tissues of the plant.

72. The method according to claim 70, wherein the composition increases wheat plant head weight by at least about 10% as compared to untreated wheat plants.

73. The method according to claim 64, wherein the composition accelerates growth rate of the plant compared to a plant not exposed to the composition.
